(19) United States
(12) Patent Application Publication
(10) Pub. No.: US 2026/0161281 A1
(43) Pub. Date: Jun. 11, 2026

(54) ENDLESS SCROLL CONTENT RETRIEVAL

(71) Applicant: Dropbox, Inc., San Francisco, CA (US)

(72) Inventors: Christopher Meeks, Austin, TX (US); Kyle Miller, Fairfax, CA (US); Adam Lindenau, Marietta, GA (US)

(21) Appl. No.: 18/977,663

(22) Filed: Dec. 11, 2024

(51) Int. Cl. G06F 3/0485

(52) U.S. Cl. CPC G06F 3/0485

(57) ABSTRACT

This disclosure describes systems that generate a single scrollable page within a scroll navigation interface of a client device. The disclosed systems group the content items into stacks and provide the stacks of content items for display within an initial viewing pane of the single scrollable page. Additionally, the disclosed systems generate and provide a set of label elements within the initial viewing pane. Responsive to a selection of a label element of the set of label elements, the disclosed systems add a new viewing pane beneath the initial viewing pane within the single scrollable page and display a subset of the content items related to the label element within the new viewing pane. Further, responsive to receiving an indication of an upward navigational input, the disclosed systems can display the initial viewing pane of the single scrollable page within the scroll navigation interface.

### BACKGROUND

Advancements in computing devices and networking technology have given rise to a variety of innovations in cloud-based digital content storage and access. For example, digital content systems can store, provide access to, and synchronize changes for, digital content items across devices all over the world. Existing systems can also provide a suite of computer functions to search, browse, organize, and store content items. Traditionally, existing digital content systems use folder-based storage systems and corresponding interfaces to organize and navigate through content items in stratified layers of folders nested within one another. Despite these advancements, existing systems suffer from a variety of technical deficiencies, especially regarding navigational efficiency and operational flexibility.

As just mentioned, many existing systems are navigationally inefficient. For example, existing systems often require excessive and onerous device interaction as a result of their folder-based interfaces for navigating among nested folder hierarchies. Indeed, locating a specific content item within a conventional system requires excessive numbers of device interactions to navigate through multiple separate windows or tabs for the stratified layers of folders, separately opening each nested folder until ultimately reaching the content item. On top of their navigational inefficiencies in requiring so many interactions, existing systems also exhibit computational inefficiencies resulting from processing the excessive interactions that could otherwise be preserved with a more efficient system.

In addition to being inefficient, some conventional systems are also inflexible. Indeed, as noted above, most existing content management systems utilize rigid storage structures made up of nested folders or directories. But the layered-folder structures of existing systems are confining by design. For example, a single content item exists in a single folder, and any versions of the same content item found in other folders are copies of the original, each constituting its own, independently stored content item. Not only does storing multiple versions or copies of a single content item consume excessive memory and storage (particularly when storing them in multiple nested layers of folders, each with its own stored file path or directory), but doing so also increases the risk of creating conflicting copies and/or introducing errors, especially in cases of content items shared among multiple user accounts. On top of these issues, searching within such systems is also quite limited. Often, search functions in conventional systems are limited to searching among predetermined paths within a nested folder hierarchy.

### SUMMARY

Embodiments of the present disclosure provide benefits and/or solve one or more of the foregoing or other problems in the art with systems, non-transitory computer-readable media, and methods for navigating and viewing content items within a content management system using an endless scroll approach. For instance, the disclosed systems can generate a scroll navigation interface that presents a viewable portion (e.g., a viewing pane) of a single scrollable page which (is expandable and contractable and) encompasses or spans the contents of a storage system. The disclosed systems thus facilitate navigating among content items organized in stacks or folders using scroll-based interactions in the single scrollable page. For instance, the disclosed systems can separate content items into viewing panes within the scrollable page, where each viewing pane corresponds to a respective content stack or folder. Thus, based on user interaction to scroll vertically up or down among viewing panes, the disclosed systems can adaptively move the scrollable page to present the content items belonging to (e.g., stored within a corresponding folder or included as part of a corresponding stack) a currently displayed viewing pane.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a continuous scroll system generating viewing panes for display within a single scrollable page of a scroll navigation interface in accordance with some embodiments.

FIG. 2 illustrates an example overview of providing a set of label elements and a search bar within the scroll navigation interface in accordance with some embodiments.

FIG. 3 illustrates a viewing pane of the scroll navigation interface according to a selection of an element of a histogram.

FIG. 4 illustrates generating a new viewing pane for display in the single scrollable page of the scroll navigation interface responsive to a selection of a label element in accordance with some embodiments.

FIG. 5 illustrates a second viewing pane for display beneath the new viewing pane within the single scrollable page of the scroll navigation interface responsive to a selection of a content item displayed within the new viewing pane.

FIG. 6 illustrates changing the content item displayed within the second viewing pane responsive to an indication of a horizontal navigational input received within the single scrollable page of the scroll navigation interface in accordance with some embodiments.

FIG. 7 illustrates a vertical scroll animation of the continuous scroll system displaying the initial viewing pane within the single scrollable page of the scroll navigation interface in response to receiving an upward navigation input in accordance with some embodiments.

FIG. 8 illustrates a schematic diagram of an example environment of a continuous scroll system in accordance with one or more embodiments.

FIG. 9 illustrates an example flowchart of a series of acts for displaying content items within a viewing pane of a single scrollable page in accordance with some embodiments.

FIG. 10 illustrates a block diagram of a computing device for implementing one or more embodiments.

FIG. 11 illustrates an example environment of a networking system having the continuous scroll system in accordance with one or more embodiments.

### DETAILED DESCRIPTION

This disclosure describes one or more embodiments of a continuous scroll system that can generate a single scrollable page within a scroll navigation interface. By scrolling through the single scrollable page, the scroll navigation interface can depict various content stacks (or collections) and/or layers of a stratified storage structure. For example, the continuous scroll system can generate viewing panes corresponding to respective stacks (or folders or namespaces) and can scroll through the viewing panes (one at a time) within the single scrollable page. In some cases, the continuous scroll system generates label elements within the scroll navigation interface by analyzing stored content items to determine groups or stacks that correspond to various labels. Responsive to receiving a selection of a label element, the continuous scroll system can generate a corresponding viewing pane to add beneath a previous viewing pane within the single scrollable page (effectively expanding the page to add the new viewing pane) and can scroll to the corresponding viewing pane to display content items associated with the selected label (while also facilitating a scroll to return to the previous viewing pane). The continuous scroll system can continue this type of navigation through the single scrollable page by populating each iteration of the scroll navigation interface with a viewing pane corresponding to a selected label element and by providing a set of label elements for labels extracted from content items in the current viewing pane.

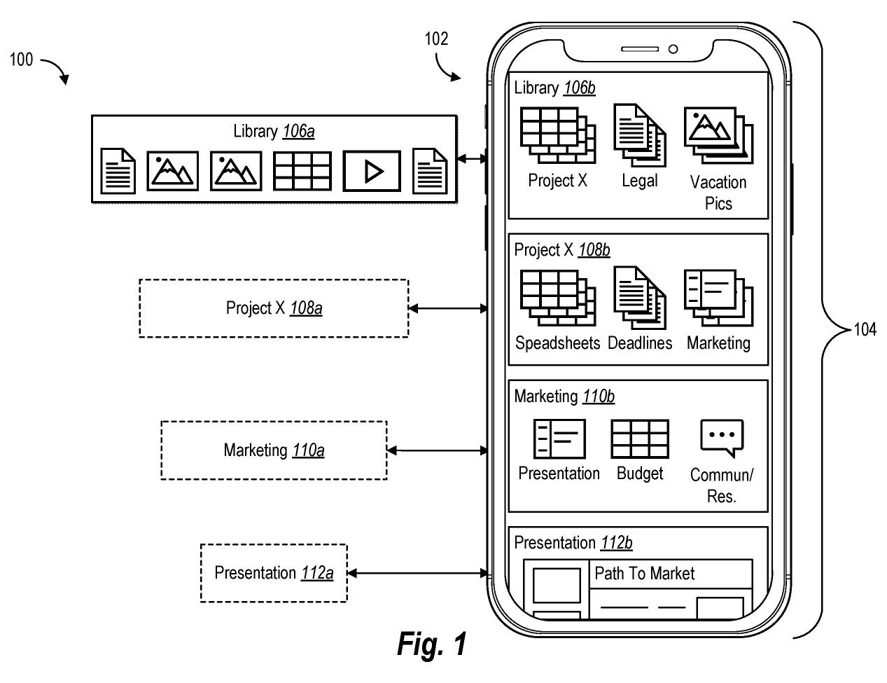

As illustrated in FIG. 1, the continuous scroll system 100 can provide a scroll navigation interface 104 for display on a client device 102. As the basis for facilitating scrollable navigation through layers or stacks of content items, the continuous scroll system 100 can generate a single scrollable page that is expandable and contractible and that is viewable in sections (or viewing panes) within the scroll navigation interface 104. Within the single scrollable page, the continuous scroll system 100 can generate an initial viewing pane 106b to display groups of content items (e.g., Project X, Legal, Vacation Pics) of a content item library 106a. In some cases, the library 106a represents a namespace, a folder, or a collection of all content items stored for a user account within a cloud storage structure, such as a content management system.

In some embodiments, the continuous scroll system 100 can further generate stacks to organize the content items in the content item library 106a. Indeed, the continuous scroll system 100 can analyze the content items in the content item library 106a to extract or generate labels defining various aspects of the content items based on actual digital content within the content items (e.g., text, image pixels, video data, calendar events, populated data fields, or other types of content) and/or based on metadata associated with the content items (e.g., content item type/format, creator user account, creation date, creation location, collaborating user accounts, access permissions, and other types of metadata). Based on extracting or generating labels, the continuous scroll system 100 can thus organize the content items of the library 106a into stacks (or collections), where each stack corresponds to a label and where a single content item (stored in a single location) can belong to multiple stacks based on its affiliated labels. Thus, the continuous scroll system 100 can organize the library 106a into content item stacks without input via the client device 102 to generate folders and relocate content items.

Along these lines, the continuous scroll system 100 can generate label elements to present within the scroll navigation interface 104, where a label element is selectable to populate the scroll navigation interface 104 with a corresponding viewing pane depicting content items associated with the selected label. In these or other embodiments, the continuous scroll system 100 can arrange content items in layered folders or directories within the library 106a, where each layer of nested folders can correspond to a label element selectable to generate a viewing pane. For example, responsive to an indication of a selection of a label element for Project X 108a, the continuous scroll system 100 can generate a new viewing pane 108b to display the corresponding stack of content items (replacing the initial viewing pane 106b within the scroll navigation interface 104). Indeed, the continuous scroll system 100 can place the new viewing pane 108b beneath the initial viewing pane 106b such that both the initial viewing pane 106b and the new viewing pane 108b are within the single scrollable page and are navigable using the scroll navigation interface 104 to scroll the single scrollable page up and down. As shown, the new viewing pane 108b is depicted below the initial viewing pane 106b with a dashed box to indicate that the continuous scroll system 100 can navigate to the new viewing pane 108b with a scroll navigation to scroll the single scrollable page, but in some cases the new viewing pane 108b is not shown together with the initial viewing pane 106b in the scroll navigation interface 104 (e.g., the scroll navigation interface 104 shows a single viewing pane at a time).

As further illustrated in FIG. 1, the continuous scroll system 100 can generate additional viewing panes for display within the scroll navigation interface 104. Responsive to an indication of a selection of a label element for marketing 110a, the continuous scroll system 100 can generate an additional viewing pane 110b to add beneath the initial viewing pane 106b and the new viewing pane 108b within the single scrollable page. The continuous scroll system 100 can thus navigate among the viewing panes in response to scroll navigation inputs. As shown, the continuous scroll system 100 can present content items (from a Marketing stack within Project X) corresponding to the marketing label for display within the additional viewing pane 110b in response to a selection of the marketing label element (or the Marketing stack).

In a similar fashion, responsive to an indication of a selection of a label element for a presentation 112a), the continuous scroll system 100 can generate a third new viewing pane 112b to display an individually selected content item (from the marketing stack). For example, the third new viewing pane 112b depicts the actual contents of a selected slide presentation, including images, text, and other content. The continuous scroll system 100 can place the third new viewing pane 112b beneath the additional viewing pane 110b such that the initial viewing pane 106b, the new viewing pane 108b, the additional viewing pane 110b, and the third new viewing pane 112b are all within the single scrollable page.

Indeed, as shown by FIG. 1, the continuous scroll system 100 can utilize the scroll navigation interface 104 to navigate the single scrollable page to access or present different viewing panes. As previously discussed, the continuous scroll system 100 can narrow content items displayed within a viewing pane according to iterative selections of stacks of content items or other elements displayed within the scroll navigation interface 104. Indeed, FIG. 1 illustrates the library 106a as the largest grouping (e.g., stack) of content items, which includes several smaller stacks (e.g., “Project X,” “Legal,” “Vacation Pics”). Project X 108a is depicted as a smaller box than the library 106a to illustrate that the Project X 108a stack is a subset of the library 106a stack (and thus necessarily contains less content items than the library 106a stack). Similarly, the marketing 110a stack is a smaller subset of the Project X 108a stack, and the presentation 112a stack is a smaller subset of the marketing 110a stack. Indeed, the third new viewing pane 112b contains a content item (e.g., “Path to Market”) that pertains to the marketing 110a stack, which in turn pertains to the Project X 108a stack.

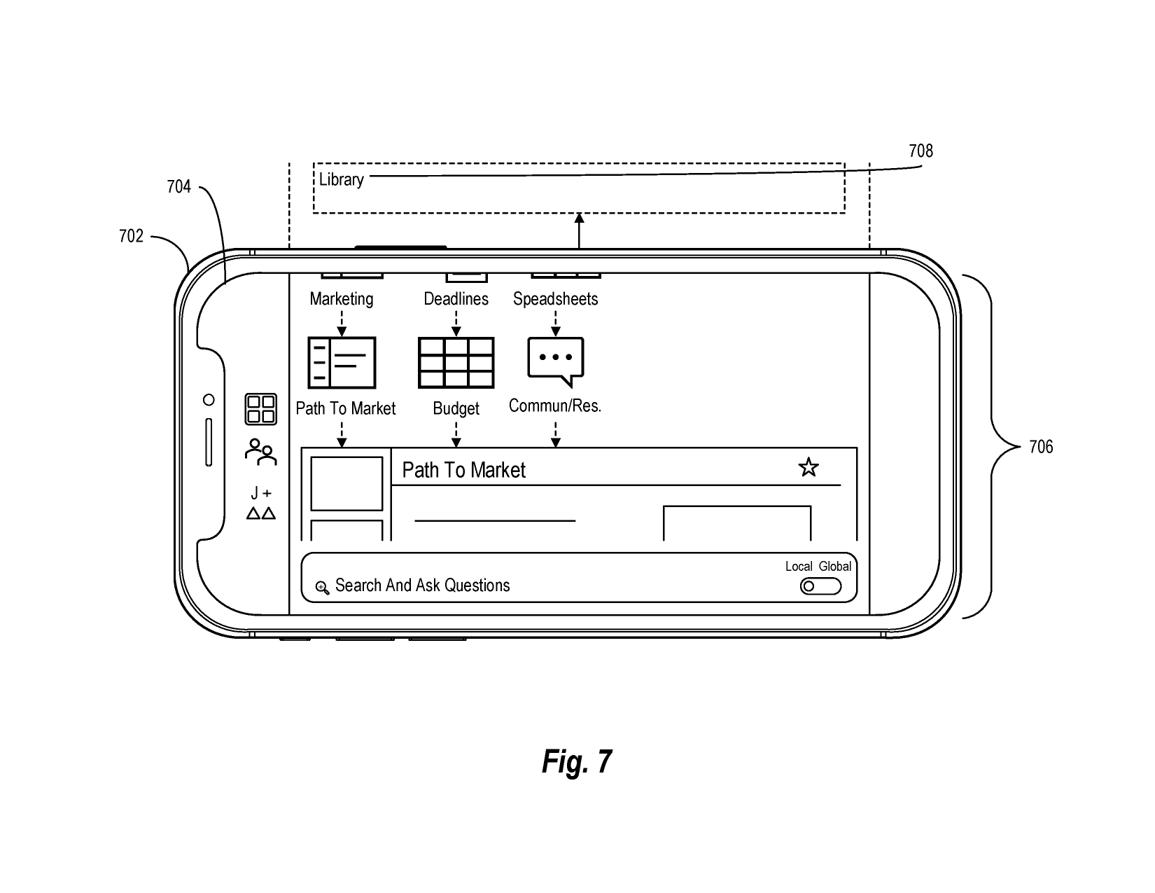

Moreover, as the discussion of FIG. 1 illustrates, the continuous scroll system 100 can update and narrow content items displayed within a viewing pane of the scroll navigation interface 104. In some embodiments, the continuous scroll system 100 can generate a new viewing pane to display content items responsive to a selection of a stack of content items. In some embodiments, the continuous scroll system 100 can generate a new viewing pane to display content items responsive to a selection of a label element. Further, the continuous scroll system 100 can update content items and/or label elements displayed within a new viewing pane according to a selection of a stack of content items or a label element. Indeed, responsive to iterative selections of stacks of content items or label elements, the continuous scroll system 100 can continually filter, narrow, or otherwise truncate content items or stacks of content items displayed within successive new viewing panes, thus providing increased granularity and level of detail for content items or stacks of content items displayed within successive viewing panes. Further, as discussed below in relation to FIG. 7, the continuous scroll system 100 can navigate back (e.g., up) through the navigation funnel (e.g., broaden what content items and/or stacks of content items are displayed within the scroll navigation interface) in response to receiving upward navigation inputs (e.g., upwards swipes, clicks, and/or scrolls).

As suggested by the foregoing discussion, the continuous scroll system 100 provides a variety of technical advantages relative to conventional systems. For example, the continuous scroll system 100 improves navigational efficiency compared to conventional computing systems. Indeed, as illustrated in FIG. 1, the continuous scroll system 100 filters content of content management systems according to selections of label elements and selections of groups of content items. Rather than requiring excessive inputs within a nested folder hierarchy to navigate through multiple separate windows, tabs, or stratified layers of folders, the continuous scroll system 100 stores content items in stacks within a single layer and navigates among the stacks within the layer according to selections of label elements received from a client device. Additionally, the continuous scroll system 100 creates new viewing panes within the single scrollable page of the scroll navigation interface responsive to the selections of label elements. By generating the single scrollable page and creating additional viewing panes within the single scrollable page, the continuous scroll system 100 eliminates the need to navigate back and forth within various levels of the traditional nested folder hierarchy and instead provides access to all content items within the content management system within a single scrollable page.

In addition, the continuous scroll system 100 can improve operational flexibility compared to conventional computing systems. As illustrated in FIG. 1, the continuous scroll system 100 redefines the concept of searching for content items within a content management system by organizing content items within stacks in a single layer. Rather than storing multiple versions of a content item to exist across various locations somewhere within stratified layers of folders, the continuous scroll system 100 organizes content items into stacks, allowing a single version of a content item to exist within multiple stacks, while only storing a single instance of the content item. Not only does the continuous scroll system 100 save computational storage and memory resources by storing only a single instance of a content item that can co-exist in many stacks, but the continuous scroll system 100 also eliminates the need to be familiar with, and navigate among, the nested folder hierarchy in order to locate items within the nested folder hierarchy. Rather, the continuous scroll system 100 stores content items in a single layer and flexibly organizes and searches the single layer according to input received from a client device.

As illustrated by the foregoing discussion, the present disclosure utilizes a variety of terms to describe features and benefits of the model modification system. Additional detail is hereafter provided regarding the meaning of these terms as used in this disclosure. As used herein, the term “content item” refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

In addition, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify computing code and/or data based on various contextual data, including information from historical user account behavior.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the model modification system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items, stacks of content items, a set of label elements) based on a plurality of inputs provided to the neural network. In some cases, a neural network refers to an algorithm (or a set of algorithms) that implements deep learning techniques to model high-level abstractions in data. A neural network can include various layers such as an input layer, one or more hidden layers, and an output layer that each perform tasks for processing data. For example, a neural network can include a deep neural network a convolutional neural network, a recurrent neural network (e.g., an LSTM), a graph neural network, a large language model (LLM), or a generative neural network.

Further, as used herein, the term “scroll navigation interface” refers to a user interface that presents portions of a single scrollable page of content items and that includes a configuration of interactive elements and controls displayed via a client device. In some cases, a scroll navigation interface enables a user account to interact with the continuous scroll system 100, a content management system, content items, among others, through a client device. The scroll navigation interface can display one or more segments of a single scrollable page (e.g., label-specific viewing panes). The scroll navigation interface can depict or present a single viewing pane at a time as part of scrolling through a single scrollable page.

Relatedly, as used herein, the term “single scrollable page” (or simply “scrollable page”) refers to a data object made up of computer code defining a continuously navigable, single layer of stored content items (e.g., organized in stacks). For example, a scrollable page includes or represents a navigation funnel for viewing and/or otherwise interacting with content items stored within a content management system. Indeed, the single scrollable page can include one or more label-specific viewing panes (e.g., sections) that display stacks of content items and/or individual content items. In some cases, a scrollable page is viewable in portions (or viewing panes) via a scroll navigation interface.

Moreover, as used herein, the term “viewing pane” (refers to a viewable segment or portion of a single scrollable page. For example, a viewing pane can include or refer to a portion of a scrollable page that fits or is viewable within a scroll navigation interface such that, as a device navigates through the scrollable page, the scroll navigation interface shows different viewing panes. In some cases, viewing panes are label-specific and can include content items corresponding to label elements or stacks. In some embodiments, viewing panes are part of a navigation funnel such that viewing panes appearing or occurring before (or above) other viewing panes corresponding to content item stacks that include or subsume the stacks (or content items) shown in the other viewing panes below.

Additionally, as used herein, the term “label element” can refer to an interface element (e.g., within a scroll navigation interface) that represents, and is selectable to display, groups (e.g., stacks) of content items. For example, in some embodiments, the continuous scroll system 100 generates a label element by determining or extracting labels from content items based on topics, associated user accounts, filetype, associated projects, associated calendar events, and/or other content item data. In some cases, the continuous scroll system 100 generates a label element based on a predicted question or prompt (e.g., a large language model prompt) corresponding to a currently displayed viewing pane or content item.

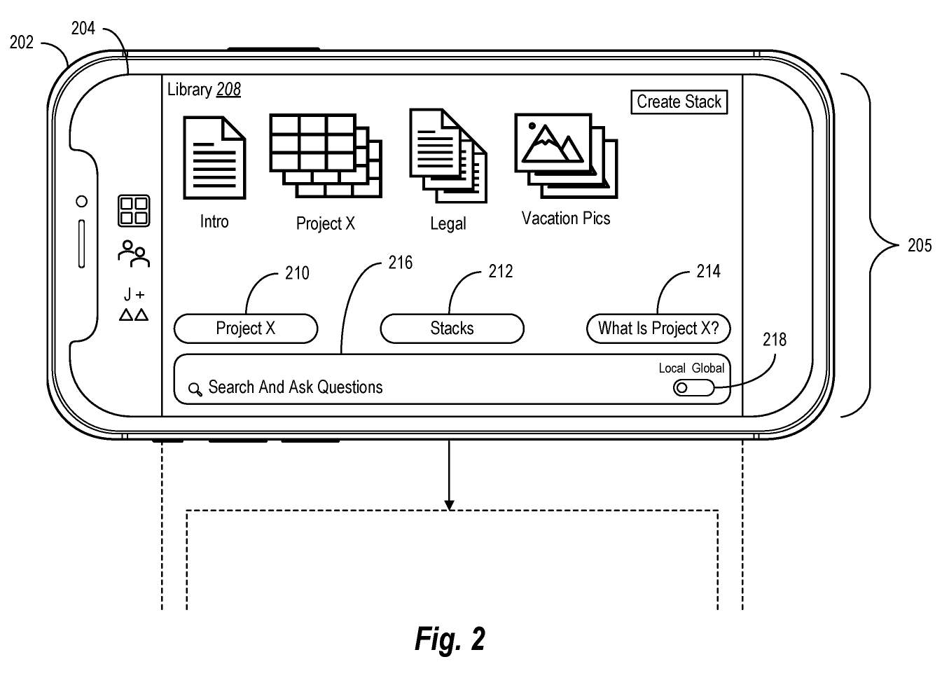

As previously mentioned, the continuous scroll system 100 can utilize label elements to modify displays of content items within the scroll navigation interface. In particular, the continuous scroll system 100 can navigate among viewing panes of a single scrollable page based on selections of label elements. FIG. 2 illustrates the continuous scroll system 100 displaying content items within an initial viewing pane and providing label elements to enable dynamic, flexible navigation of content items displayed within a scroll navigation interface in accordance with one or more embodiments.

As shown in FIG. 2 the continuous scroll system 100 displays an initial viewing pane 205 of the scroll navigation interface 204 on a client device 202. The initial viewing pane 205 can include a combination of individual content items (e.g., “Intro”), stacks of content items (e.g., “Project X,” “Legal,” and “Vacation Pics”), a set of label elements 210-214, a search element 216, as well as an element selectable to create a stack of content items (e.g., the “Create Stack” button).

Indeed, the continuous scroll system 100 can automatically determine the set of label elements 210-214 (e.g., a first label element 210 labeled “Project X,” a second label element 212 labeled “Stacks,” and a third label element 214 labeled “What is Project X”) according to several factors. For example, the continuous scroll system 100 can determine the set of label elements 210-214 according to metadata associated with content items, user account associated with the content items, and/or previous interactions with the content items. Further, the set of label elements 210-214 can be selectable to create additional viewing panes for presenting content items corresponding to respective labels (e.g., a first label element 210 labeled “Project X” and a second label element labeled “Stacks”) or to present information about stacks of content items (e.g., a third label element 214 labeled “What is Project X?”).

As noted, the continuous scroll system 100 can create the set of label elements 210-214 according to metadata of content items displayed within the initial viewing pane 205. Indeed, the continuous scroll system 100 can determine content items and/or stacks within the initial viewing pane 205 and can analyze the content items to extract labels for the set of label elements 210-214. The set of label elements 210-214 can thus be related to one or more stacks of content items, such as the first label element 210 for a label of “Project X.” Additionally or alternatively, the continuous scroll system 100 can generate the third label element 214 (“What is Project X”) by determining or predicting a prompt or question. For instance, the continuous scroll system 100 can generate a prompt corresponding to one or more labels of content items within the initial viewing pane 205.

Further, as illustrated, the continuous scroll system 100 can include the search element 216 within the scroll navigation interface 204. Through the search element 216, the continuous scroll system 100 can receive queries (e.g., such as a natural language input or prompt from a user account associated with the client device 202) regarding content displayed in the scroll navigation interface 204 or otherwise contained within the content management system. Responsive to receiving the prompt or input, the continuous scroll system 100 can perform a search of content items within the content management system to identify content items relating to the query or prompt. Further, the search element 216 can include a search mode toggle 218 selectable to change a scope of the search between a local search mode (e.g., for searching among content items and stacks confined to the currently displayed viewing pane) and a global search mode (e.g., for searching among content items and stacks among all viewing panes of the single scrollable page). Indeed, the continuous scroll system 100 can utilize the local search mode to search within a current viewing pane and the global search mode to search content within an entirety of a scrollable page.

Additionally, the continuous scroll system 100 can include a viewing pane label 208 corresponding to a stack that the continuous scroll system 100 is displaying in the single scrollable page (e.g., a level of the viewing pane within the navigation funnel). For example, the viewing pane label 208 displays the text “Library,” indicating that the continuous scroll system 100 is displaying content items and stacks of content items from a library (e.g., the widest point of the navigation funnel including all content items associated with a user account).

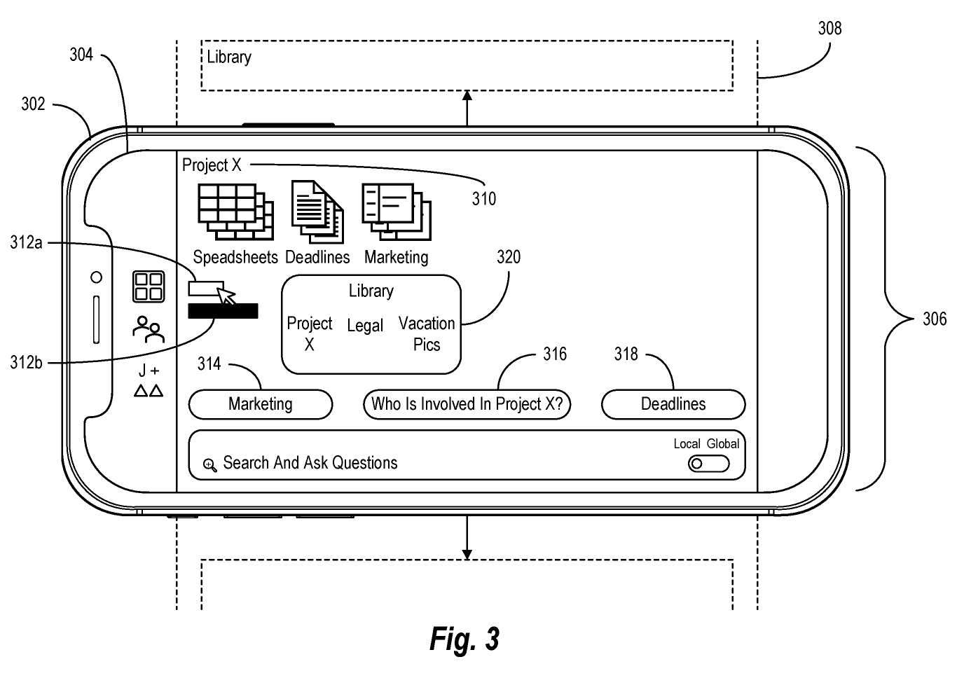

As previously mentioned, the continuous scroll system 100 can generate a new viewing pane and display a filtered subset of content items within the new viewing pane. In particular, the continuous scroll system 100 can expand the single scrollable page to add additional viewing panes for viewing within a scroll navigation interface. FIG. 3 illustrates the continuous scroll system 100 generating a new viewing pane in response to detecting an indication of an interaction with an object in the initial viewing pane (e.g., the initial viewing pane 205 of FIG. 2).

In one or more embodiments, the continuous scroll system 100 enables downward vertical navigation through the single scrollable page through interactions with content items (e.g., “Intro” as shown in FIG. 2), stacks of content items (e.g., “Project X,” “Legal,” or “Vacation Pics” as shown in FIG. 2), label elements (e.g., the first label element 210, the second label element 212, and/or the third label element 214 of FIG. 2), or search elements (e.g., the search element 216 of FIG. 2). Indeed, responsive to detecting an interaction with an object within the initial viewing pane 205 of the scroll navigation interface 204 (e.g., such as a content item, a stack of content items, a label element, or a search element, among others) the continuous scroll system 100 can generate a new viewing pane beneath the initial viewing pane 205 within the single scrollable page. Accordingly, the continuous scroll system 100 can continually and expand the single scrollable page by adding additional viewing panes responsive to detecting an indication of an interaction with an object displayed within a current level/viewing pane of the single scrollable page.

Moreover, as the continuous scroll system 100 expands the single scrollable page, the continuous scroll system 100 stores previous viewing panes of the single scrollable page in a memory buffer. By storing the previous viewing panes in the memory buffer, the single scrollable page enables upward navigation from a current viewing pane to any one of the previous panes. Indeed, the continuous scroll system 100 can, responsive to detecting an indication of an interaction within a current viewing pane, such as an upward swipe or a tap, the continuous scroll system 100 can scroll upwards through the single scrollable page to a previous viewing pane displayed within the single scrollable page. In some cases, the continuous scroll system 100 prevents downward scrolling by erasing memory of viewing panes below a currently displayed viewing pane (instead requiring new inputs with elements or items to delve deeper) and only facilitates upward scrolling through viewing panes stored in memory above the current viewing pane. More information regarding the continuous scroll system 100 scrolling upwards through the single scrollable page to return to a previous viewing pane is provided below with regard to FIG. 7.

As further illustrated in FIG. 3, the continuous scroll system 100 can generate a new viewing pane 306 of a single scrollable page to display in a scroll navigation interface 304 (e.g., the scroll navigation interface 204 of FIG. 2) of a client device 302. Indeed, the continuous scroll system 100 can generate the new viewing pane 306 in response to detecting an indication of an interaction with an element (e.g., such as a stack of content items or a label element, such as the first label element 210) of an initial viewing pane 308 of the single scrollable page. The indication of the interaction can be a click, a tap, or a hover, among others. The continuous scroll system 100 reduce or otherwise change the content items, stacks of content items, and/or set of label elements displayed within the new viewing pane 306 according to the indication of the interaction with an element of the initial viewing pane 308. Indeed, the continuous scroll system 100 thus expands the scrollable page to add the new viewing pane 306 (below) and in some embodiments automatically navigates vertically downward from the initial viewing pane 308 for “Library” to the new viewing pane 306 for “Project X.”

As shown, the continuous scroll system 100 can provide a viewing pane label 310 of a stack displayed in the new viewing pane 306. For example, the viewing pane label 310 shows that content items within “Project X” are displayed in the new viewing pane 306. Indeed, the new viewing pane 306 includes stacks of content items (e.g., “Spreadsheets,” “Deadlines,” and “Marketing,”) and a set of label elements 314-318 (e.g., a first label element 314 labeled “Marketing,” a second label element 316 labeled “Who Is Involved In Project X?” and a third label element 318 labeled “Deadlines”) related to the “Project X” stack of FIG. 2.

Additionally, as shown in FIG. 3, the continuous scroll system 100 can generate a histogram to include in a viewing pane of the single scrollable page. The histogram can include a plurality of viewing pane elements (e.g., 312a and 312b) corresponding to respective viewing panes within the single scrollable page (where non-viewable portions of the single scrollable page are represented by the dashed lines in FIG. 3). For example, as illustrated, the histogram can include a first viewing pane element 312a that corresponds to the initial viewing pane 308 (e.g., the initial viewing pane 205 of FIG. 2) and a second viewing pane element 312b that corresponds to the new viewing pane 306, both of which have been viewed as part of the same session or journey. Additionally, responsive to detecting an indication of an interaction, such as a hover, with the histogram, (such as shown by a mouse icon hovering over the first viewing pane element 312a), the continuous scroll system 100 can provide a preview 320 within a sub-window of the viewing pane that corresponds to the viewing pane element (e.g., the first viewing pane element 312a) selected within the histogram . Indeed, as the continuous scroll system 100 adds viewing panes to the single scrollable page, the continuous scroll system 100 can add corresponding viewing pane elements to the histogram element.

Indeed, as discussed, the continuous scroll system 100 can utilize the histogram element to summarize content of the single scrollable page within a current viewing pane of the single scrollable page, and to provide selectable viewing-pane-specific elements to navigate back to particular viewing panes in a single interaction. In some embodiments, the continuous scroll system 100 can utilize additional or alternative user interface elements to summarize content of the single scrollable page, or specific parts (e.g., viewing panes) of the single scrollable page. For example, in some embodiments, the continuous scroll system 100 can generate a bar chart element comprising a plurality of column elements that correspond to viewing panes of the single scrollable page. Indeed, the continuous scroll system 100 can determine a size of each of the plurality of column elements according to an amount of information displayed or otherwise contained in a viewing pane that corresponds to each of the plurality of column elements. Indeed, in some embodiments, the continuous scroll system 100 can determine a size of each of the plurality of column elements according to an order of viewing pane elements that corresponds to each of the column elements (e.g., the continuous scroll system 100 can determine a size of each of the column elements that is inversely proportional to an order of the viewing pane elements that correspond to the column elements, such a column element that corresponds to an initial viewing pane having a smallest size relative to a column element that corresponds to a current viewing pane having a largest size.

In some embodiments, the continuous scroll system 100 can determine relative sizes of each of the viewing pane elements according to an order of viewing panes within the single scrollable page. For example, as illustrated, the continuous scroll system 100 can make a first size of the first viewing pane element 312a smaller than a second size of the second viewing pane element 312b to indicate that the second viewing pane element 312b corresponds to a current viewing pane (e.g., the new viewing pane 306) or a more recently displayed viewing pane and that the first viewing pane element 312a corresponds to a previous viewing pane (e.g., the initial viewing pane 308) or a less recently displayed viewing pane.

Moreover, in some embodiments, the continuous scroll system 100 can determine relative sizes of each of the viewing pane elements according to an amount of information contained in a viewing pane corresponding to the viewing pane element. For example, the continuous scroll system 100 can generate a first viewing pane element that corresponds to an initial viewing pane and a second viewing pane element that corresponds to a new viewing pane. The continuous scroll system 100 can generate the first viewing pane element to have a larger size relative to the second viewing pane element to indicate that the first viewing pane element corresponds to the viewing pane that contains more information and/or content items than the new viewing pane that corresponds to the second viewing pane element.

Moreover, as shown, responsive to an indication of an upward navigational input, such as a swipe, a click (e.g., in a top margin or a bottom margin), or a scroll, the continuous scroll system 100 can vertically scroll the single scrollable page upwards to the initial viewing pane 308 (e.g., the “Library”). Additionally, in some embodiments, the continuous scroll system 100 can vertically scroll the single scrollable page upwards to the initial viewing pane 308 responsive to an indication of an interaction with the viewing pane element of the histogram element that corresponds to the initial viewing pane 308.

Indeed, in some embodiments, the continuous scroll system 100 can vertically scroll the single scrollable page upwards to the initial viewing pane, responsive to detecting first indication of a first type of interaction (e.g., a click or a tap) with a top margin of a current viewing pane of the single scrollable page. Moreover, in some embodiments, the continuous scroll system 100 can vertically scroll the single scrollable page upwards to the initial viewing pane responsive to detecting a second indication of a second type of interaction (e.g., an upward swipe) within a current viewing pane of the single scrollable page. For example, the continuous scroll system 100 can determine that an indication of a type of interaction is the second indication of the second type by determining that the indication of the type of interaction exceeds a bounce boundary. The bounce boundary can be a threshold velocity, a threshold duration, and/or a threshold distance. Further, in some embodiments, the bounce boundary can include a plurality of threshold velocities, a plurality of threshold durations, and/or a plurality of threshold distances to determine a previous viewing pane of the single scrollable page to return to. For example, the single scrollable page can determine that the second indication of the second type of interaction exceeds a first threshold velocity, but not a second threshold velocity. Responsive to determining that the second indication of the second type of indication exceeds the first threshold velocity but not the second threshold velocity, the continuous scroll system 100 can scroll upwards through the single scrollable page to a viewing pane one level above a current viewing pane of the single scrollable page. Further, the continuous scroll system 100 can determine that an indication of an interaction does not exceed the bounce boundary and cause the single scrollable page to return (e.g., “bounce”) back to a current viewing pane rather than returning to the initial viewing pane.

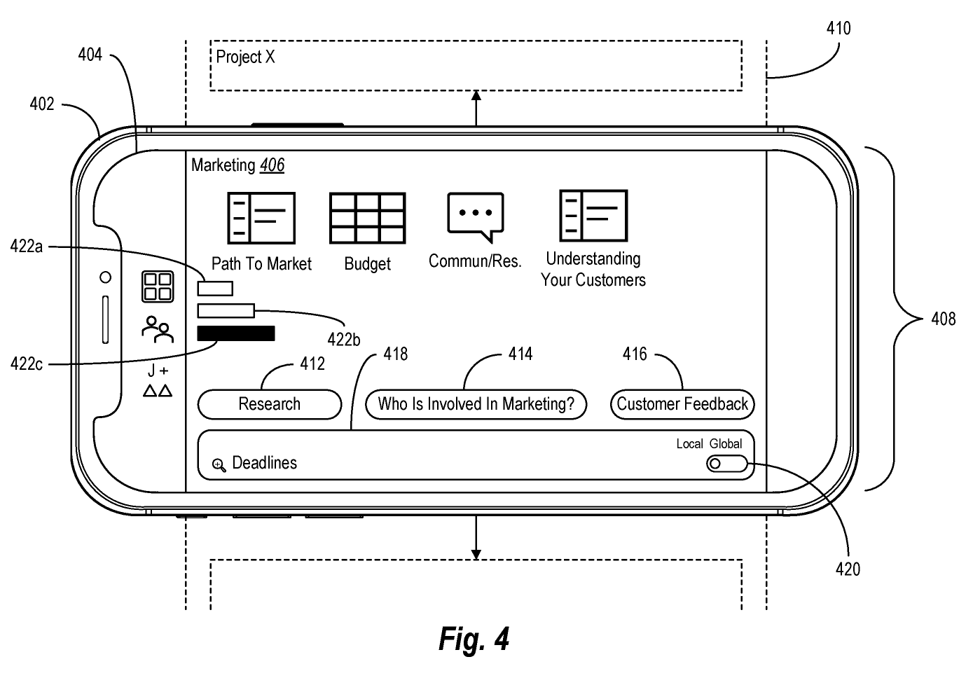

As previously mentioned, responsive to an indication of an interaction with an element in the new viewing pane 306 of the single scrollable page (e.g., such as a label element of the set of label elements 314-318 or a stack of content items), the continuous scroll system 100 can expand the single scrollable page to generate an additional viewing pane and can place the additional viewing pane beneath the new viewing pane within the single scrollable page. FIG. 4 illustrates the continuous scroll system 100 generating an additional viewing pane 408 and displaying the additional viewing pane 408 in a scroll navigation interface 404 of a client device 402 in accordance with one or more embodiments.

As shown in FIG. 4, the continuous scroll system 100 can generate the additional viewing pane 408 responsive to detecting an indication of an interaction with a label element of the set of label elements 314-318 of FIG. 3 (e.g., the first label element 314 labeled “Marketing”) in a new viewing pane 410 (e.g., the new viewing pane 306 of FIG. 3). In response to the selection, the continuous scroll system 100 can place the additional viewing pane 408 beneath the new viewing pane 410 within the single scrollable page and can scroll vertically downward to present the additional viewing pane 408 within the scroll navigation interface 404.

As illustrated, within the additional viewing pane 408, the continuous scroll system 100 can provide a viewing pane label 406 (e.g., “Marketing”) of a scope (e.g., stack or group) of content items displayed within the additional viewing pane 408. Further, the continuous scroll system 100 can populate the additional viewing pane 408 with content items related to marketing (e.g., “Presentation,” “Budget,”) as well as stacks of content items related to marketing (e.g., “Commun/Res.”)—e.g., as sub-stacks within the “Marketing” stack. Moreover, based on the content items within the additional viewing pane 408, the continuous scroll system 100 can generate an updated set of label elements 412-416 (e.g., a first updated label element 412 “Path to Market,” a second updated label element 414 “Who Is Involved in Marketing?” and a third updated label element 416 “Customer Feedback.” The continuous scroll system 100 can display the updated set of label elements 412-416 within the additional viewing pane 408.

Additionally, as shown, responsive to generating the additional viewing pane 408, the continuous scroll system 100 can update a histogram element to include a plurality of viewing pane elements (e.g., 422a, 422b, and 422c) that correspond to viewing panes of the single scrollable page. For example, the continuous scroll system 100 can generate a first viewing pane element 422a that corresponds to an initial viewing pane (e.g., the initial viewing pane 205 of FIG. 2). Additionally, the continuous scroll system 100 can generate a second viewing pane element 422b that corresponds to a new viewing pane (e.g., the new viewing pane 306 of FIG. 3). Further, the continuous scroll system 100 can generate a third viewing pane element 422c that corresponds to the additional viewing pane 408. The continuous scroll system 100 can continually update the histogram element to include subsequent viewing pane elements corresponding to the number of viewing panes added to the single scrollable page.

Indeed, in some embodiments, the continuous scroll system 100 can determine sizes of the plurality of viewing pane elements (e.g., 422a, 422b, and 422c) of the histogram element to indicate an organization or order of viewing panes of the single scrollable page that correspond to respective viewing panes of the plurality of viewing pane elements. For example, as shown in FIG. 4, the continuous scroll system 100 generates the first viewing pane element 422a to have a first size that is smaller than a second size of the second viewing pane element 422b and smaller than a third size of the third viewing pane element 422c, thus indicating that the viewing pane that corresponds to the first viewing pane element 422a (e.g., the initial viewing pane 205 of FIG. 2), is more removed from the additional viewing pane 408 compared to the viewing pane that corresponds to the second viewing pane element 422b (e.g., the new viewing pane 306 of FIG. 3). Similarly, the continuous scroll system 100 generates the second viewing pane element 422b to have a second size that is larger than the first size of the first viewing pane element 422a but smaller than the third size of the third viewing pane element 422c to indicate that the viewing pane that corresponds to the second viewing pane element 422b (e.g., the new viewing pane 306 of FIG. 3) is closer to the additional viewing pane 408 than the viewing pane that corresponds to the first viewing pane element 422a (e.g., the initial viewing pane 205 of FIG. 2). Similarly, the continuous scroll system 100 can generate the third size of the third viewing pane element 422c to indicate that the viewing pane that corresponds to the third viewing pane element (e.g., the additional viewing pane 408) is a current viewing pane of the single scrollable page.

In some embodiments, the continuous scroll system 100 can determine a size for each of the plurality of viewing pane elements according to an amount of content items or stacks of content items contained in the viewing pane that corresponds to each of the viewing pane elements. As shown, the histogram element includes three viewing pane elements (e.g., a first viewing pane element, at the top of the histogram element, a second viewing pane element, in a middle of the histogram element, and a third viewing pane element, at a bottom of the histogram element). Indeed, the first viewing pane element can correspond to an initial viewing pane (e.g., the initial viewing pane 205 of FIG. 2) the second viewing pane element can correspond to a new viewing pane (e.g., the new viewing pane 306 of FIG. 3), and the third viewing pane element can correspond to an additional viewing pane (e.g., the additional viewing pane 408).

The continuous scroll system 100 can determine a size of each of the viewing pane elements according to an amount of content items, stacks of content items contained within the viewing pane that corresponds to the viewing pane element, or according to another metric that indicates an amount of information or content contained within the viewing pane that corresponds to the viewing pane element. Accordingly, the first viewing pane element is larger than the second viewing pane element and the third viewing pane element because the initial viewing pane (e.g., that corresponds to the first viewing pane element) represents a viewing pane that contains more content items/stacks of content items than other viewing panes within the single scrollable page. In turn, the second viewing pane element is smaller than the first viewing pane element but larger than the third viewing pane element because the second viewing pane element (e.g., that corresponds to the new viewing pane) represents a viewing pane that contains less content items (and/or stacks of content items) than the initial viewing pane, but that contains more content items than the additional viewing pane. Further, the third viewing pane element is smaller than the first viewing pane element and the second viewing pane because the third viewing pane element represents a viewing pane that contains less content items (and/or stacks of content items) than the initial viewing pane and the new viewing pane.

Further, the continuous scroll system 100 can provide a preview of a viewing pane corresponding to a viewing pane element responsive to detecting an indication of a first type of interaction (e.g., such as a hover) with the viewing pane element of the histogram element. Moreover, responsive to detecting an indication of a second type of interaction (e.g., such as a click or a tap) with a viewing pane element of the histogram element, the continuous scroll system 100 can provide the viewing pane that corresponds to the viewing pane element for display on the single scrollable page in the scroll navigation interface 404. In this manner, the continuous scroll system 100 increases the efficiency and operational flexibility of implementing systems by providing previews of different stacks within the scroll navigation interface without requiring repetitive interactions to view or locate a content item. The continuous scroll system 100 further provides single-input navigation to jump between viewing panes of the scrollable page—without needing to traverse (upward) through each individual pane one at a time—by selecting a viewing pane element of the histogram.

Further, the continuous scroll system 100 can provide a search element 418 within the additional viewing pane 408. Indeed, the continuous scroll system 100 can receive, via the search element 418, prompts or queries regarding stacks of content items. Indeed, the search element 418 can include a search mode toggle 420. The continuous scroll system 100 can generate the search mode toggle 420 to be selectable to alternate between a local search mode for searching content within a current viewing pane (e.g., the additional viewing pane 408), and a global search mode for searching content within the single scrollable page or the entire library. Indeed, as shown, responsive to detecting an interaction with the search mode toggle 420, the continuous scroll system 100 sets the search mode toggle to “Global” and searches all content within the library or the single scrollable page for “Deadlines” (e.g., the “Deadlines” stack of the new viewing pane 306 displayed in FIG. 3).

Additionally, in some embodiments, the continuous scroll system 100 can detect an indication of an interaction (e.g., an upwards swipe, tap, or scroll) that exceeds a bounce boundary within the scroll navigation interface and, responsive to detecting the indication of the interaction within the scroll navigation interface, cause the scroll navigation interface to scroll upwards through the single scrollable page and return to the initial viewing pane. The continuous scroll system 100 can detect this indication of an interaction at any point from any level (e.g., viewing pane) of the single scrollable page.

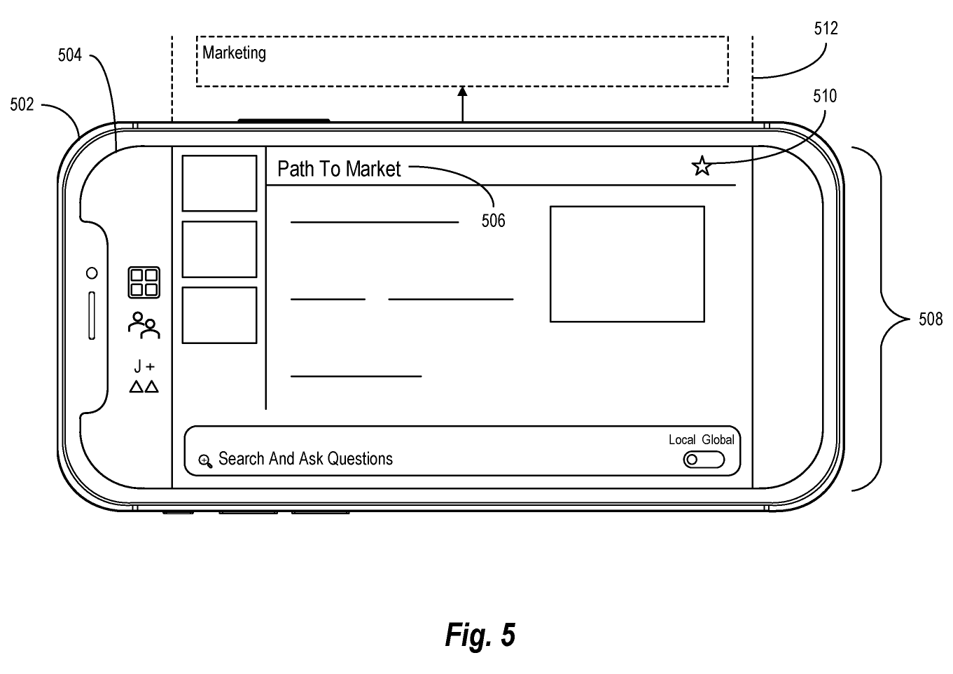

As noted above, the continuous scroll system 100 can generate and provide a content-item-specific viewing pane for viewing a single content item. In particular, responsive to detecting an indication of an interaction with a content item displayed in a viewing pane of the single scrollable page (e.g., such as the initial viewing pane 205 of FIG. 2, the new viewing pane 306 of FIG. 3, or the additional viewing pane 408 of FIG. 4, among others), the continuous scroll system 100 can provide the content item for display within an item viewing pane of the single scrollable page. FIG. 5 illustrates the continuous scroll system 100 displaying a content item 506 in an item viewing pane 508 of the single scrollable page in accordance with one or more embodiments.

As illustrated in FIG. 5, the continuous scroll system 100 can display the content item 506 (e.g., “Path To Market”) within the item viewing pane 508 of a scroll navigation interface 504 (e.g., the scroll navigation interface 404 of FIG. 4). Specifically, based on a selection of a single content item from a previous viewing pane, the continuous scroll system 100 can generate and display the item viewing pane 508 on a client device 502 at a bottom level of the single scrollable page. Indeed, the bottom level can be an end of the single scrollable page designated for viewing internal contents of individual content items. For example, the continuous scroll system 100 can place the item viewing pane 508 at the bottom level beneath an additional viewing pane 512 (e.g., the additional viewing pane 408 of FIG. 4 for viewing “Marketing”).

Additionally, as shown, the continuous scroll system 100 can provide a position anchor element 510 within the item viewing pane 508. Specifically, the continuous scroll system 100 can determine a plurality of navigational interactions (e.g., a series of indications of interactions within the scroll navigation interface, such as a combination of taps, clicks, hovers, and/or swipes of stacks, content items, and/or label elements) within the item viewing pane 508 that ultimately led to the item viewing pane 508. For example, the continuous scroll system 100 can determine that displaying the content item 506 within the item viewing interface is a result of the following navigational instructions: receiving an indication of an interaction with the first label element 210 (e.g., the label element labeled “Project X”) within the initial viewing pane 205 of FIG. 2, receiving an interaction with the first label element 314 labeled “Marketing” of FIG. 3, and subsequently receiving an indication of an interaction with the content item labeled “Path to Market” of FIG. 4. Responsive to an indication of an interaction with the position anchor element 510, the continuous scroll system 100 can store the navigational instructions in the position anchor element 510.

The continuous scroll system 100 can provide an option within an initial viewing pane (e.g., the initial viewing pane 205 of FIG. 2) to return to an anchored position (e.g., the item viewing pane 508) corresponding to the position anchor element 510. Responsive to an indication of an interaction with the position anchor element 510, the continuous scroll system 100 can save the plurality of navigational instructions to generate the item viewing pane 508. Thus, in response to a selection of an option to return to an anchored position (from one or more other viewing panes or an anchor position interface), the continuous scroll system 100 can re-apply the saved interactions to generate the item viewing pane 508.

In some embodiments, the continuous scroll system 100 can utilize the position anchor element 510 to save or otherwise bookmark search parameters for any series of interactions (e.g., the plurality of navigational instructions) within the scroll navigation interface 504. For example, the continuous scroll system 100 can utilize the position anchor element to save a plurality of navigational instructions that generated contents of a new viewing pane (e.g., the contents displayed in the new viewing pane 306 of FIG. 3 relating to Project X), the contents of an additional viewing pane (e.g., the contents displayed in the additional viewing pane 408 of FIG. 4 relating to marketing for Project X), or the contents of subsequent or alternative viewing panes created by additional or alternative pluralities of navigational interactions.

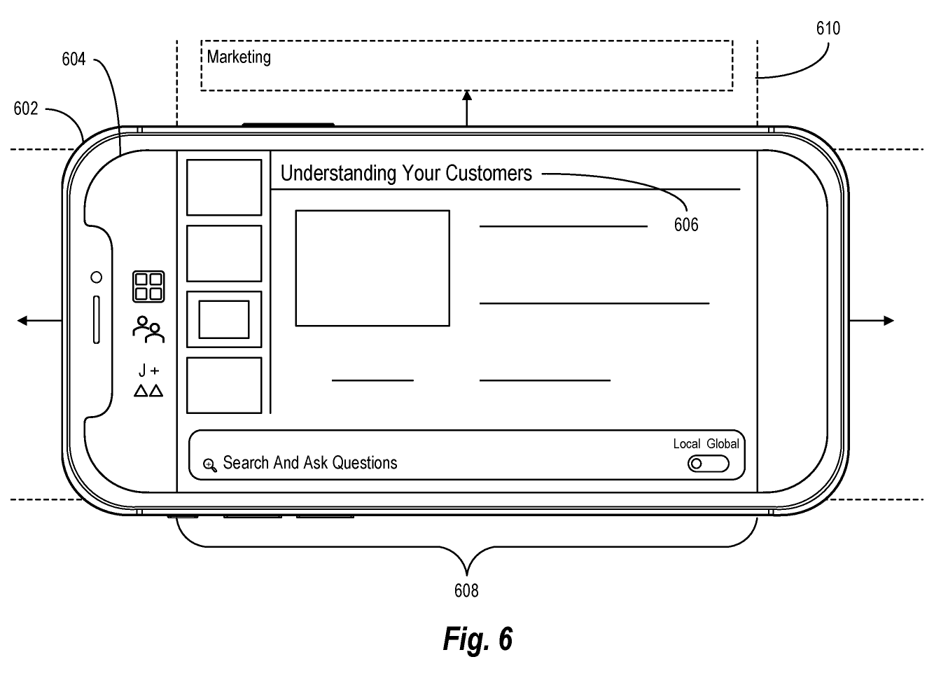

In some embodiments, the continuous scroll system 100 can generate a horizontal scroll viewing pane. In particular, the continuous scroll system 100 can generate a horizontal scroll viewing pane that is scrollable in a horizontal (e.g., left-right) direction while the navigation between viewing panes of the scrollable page is vertical (e.g., up-down). FIG. 6 illustrates the continuous scroll system 100 generating a horizontal scroll viewing pane within the single scrollable page in accordance with one or more embodiments.

The continuous scroll system 100 can generate a horizontal scroll viewing pane 608 within a scroll navigation interface 604 of a client device 602. Indeed, the continuous scroll system 100 can utilize the horizontal scroll viewing pane 608 to enable horizontal scrolling among content items within a stack of the content management system (e.g., a bottom level of the single scrollable page). For example, the continuous scroll system 100 can generate the horizontal scroll viewing pane 608 by enabling an item viewing pane (e.g., the item viewing pane 508 of FIG. 5) to receive horizontal navigational inputs (e.g., a horizontal swipe, a tap/click on a right side of the screen, or a tap/click on a left side of the screen) and switch from displaying a first content item to a second content item. In some cases, the continuous scroll system 100 generates the horizontal scroll viewing pane 608 based on detecting a selection of a stack including (at least a threshold number or proportion of) of a particular type of content item, such as digital images.

For example, the continuous scroll system 100 can detect a selection of a first content item 606 in the form of a slide deck or a presentation (e.g., “Understanding Your Customers,”) from a stack of content items 610 (e.g., “Marketing” of FIG. 4). Responsive to the selection, the continuous scroll system 100 determines that the content item type is compatible with horizontal scrolling to view components of the selected stack/content item. Accordingly, in response to receiving an indication of a horizontal navigational input, the continuous scroll system 100 can display a second content item (e.g., image or slide) within the horizontal scroll viewing pane 608. For example, responsive to receiving the indication of the horizontal navigational input, the continuous scroll system 100 can replace the first content item 606 with a second content item (e.g., “Path to Market” or “Budget” of FIG. 4).

Indeed, the continuous scroll system 100 can utilize the horizontal scroll viewing pane 608 to switch displays between content items, stacks of content items, or combinations of content items and stacks of content items. For example, in some embodiments, the continuous scroll system 100 can, responsive to receiving the indication of the horizontal navigational inputs, change from displaying a first content item to a second content item, or change from displaying a first content item to a first subset of content items (e.g., a stack), or change from displaying a first subset of content items to a second subset of content items. Further, in some embodiments, the continuous scroll system 100 can implement the horizontal scroll viewing pane 608 at a bottom level of the single scrollable page in the scroll navigation interface 604. Further, in some embodiments, the continuous scroll system 100 can generate and/or implement the horizontal scroll viewing pane at any level (e.g., a current level of the single scrollable page in the scroll navigation interface 604).

In some embodiments, the continuous scroll system 100 can implement the horizontal scroll viewing pane 608 at an intermediary level of the single scrollable page in the scroll navigation interface 604 (e.g., at a viewing pane other than an initial viewing pane and other than an item viewing pane). Further, when implementing the horizontal scroll viewing pane 608, the continuous scroll system 100 limits content items or stacks of content items displayed within the horizontal scroll viewing pane to a single level/stack. For example, as indicated by the stack of content items 610 (e.g., “Marketing”), the first content item 606 is from the stack of content items 610. When utilizing the horizontal scroll viewing pane 608, the continuous scroll system 100 only enables navigation within the stack of content items 610.

As previously mentioned, the continuous scroll system 100 can generate an animation depicting a transition between one viewing pane and another within a scrollable page. In particular, the continuous scroll system 100 can generate a vertical scroll animation that portrays the visual transformation of a scroll navigation interface scrolling between viewing panes of the scrollable page. FIG. 7 illustrates the continuous scroll system 100 generating a vertical scroll animation of the single scrollable page upward from a current viewing pane to a previous viewing pane in accordance with one or more embodiments.

As shown, the continuous scroll system 100 can generate a vertical scroll animation 706 of the single scrollable page. Indeed, responsive to receiving, via a scroll navigation interface 704 on a client device 702, an upward navigation input (or an indication of an upward navigation input), such as a vertical scroll, a click, or a swipe, the continuous scroll system 100 can generate the vertical scroll animation 706 by providing visual indicia of vertically scrolling content that reflects a change from the new viewing pane of the single scrollable page back to an initial viewing pane of the single scrollable page. The current viewing pane of the single scrollable page can be any viewing pane other than the initial viewing pane. For example, the current viewing pane can be the horizontal scroll viewing pane 608 of FIG. 6, the item viewing pane 508 of FIG. 5, the additional viewing pane 408 of FIG. 4, the new viewing pane 306 of FIG. 3, or another viewing pane of the single scrollable page.

As shown, the vertical scroll animation can include animated indicia of the continuous scroll system 100 scrolling upwards through successive viewing panes of the single scrollable page, by navigating upwards through continually larger stacks of content items. For example, the visual indicia include pixels changing or transforming to convey the impression of content items moving or sliding vertically downward. As part of the animation, the continuous scroll system 100 modifies pixels to animate the current viewing pane sliding downward out of view (over a number of frames) while simultaneously depicting content items, stacks, and other interface elements sliding into view from the top (e.g., as though the previous viewing pane is sliding down).

In some cases, based on a series of navigational inputs to scroll upward through the viewing panes of the scrollable page, the continuous scroll system 100 animates changes from a content item (e.g., “Path to Market”) to an additional viewing pane displaying a stack of content items related to (e.g., “Presentation,” “Budget,” and “Commun/Res.”), to a new viewing pane displaying a Project X stack of content items (e.g., “Marketing,” “Deadlines,” and “Spreadsheets,”), to an initial viewing pane 708 displaying a library. Indeed, the vertical scroll animation 706 can include visual indicia relating to each viewing pane of the single scrollable page.

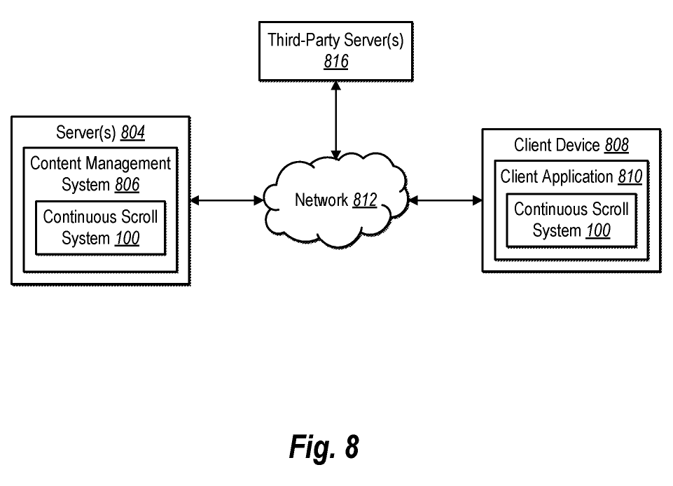

Additional detail regarding the continuous scroll system will now be provided with reference to the figures. For example, FIG. 8 illustrates a schematic diagram of an example system environment for implementing a continuous scroll system 100 in accordance with one or more implementations.

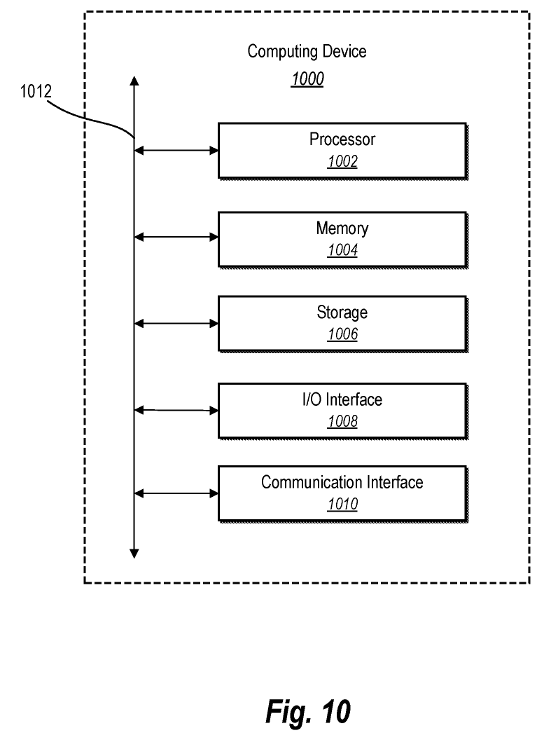

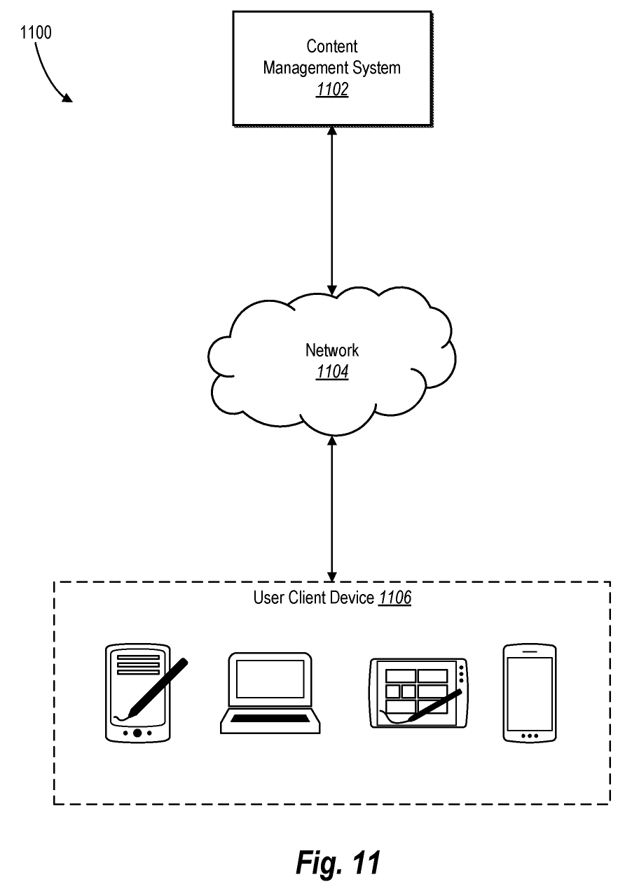

As shown, the environment includes server(s) 804, a client device 808 (e.g., the client devices described herein), third-party servers 816 and a network 812. Each of the components of the environment can communicate via the network 812, and the network 812 may be any suitable network over which computing devices can communicate. Example networks are discussed in more detail below in relation to FIGS. 10-11.

As mentioned above the example environment includes a client device 808. The client device 808 can be one of a variety of computing devices, including a smartphone, a tablet, a smart television, a desktop computer, a laptop computer, a virtual reality device, an augmented reality device, or another computing device as described in relation to FIGS. 10-11. The client device 808 can communicate with the server(s) 804 via the network 812. For example, the client device 808 can receive user input from a user interacting with the client device 808 (e.g., via a client application 810) to, for instance, access, generate, modify, or share a content item, to collaborate with a co-user of a different client device, or to select a user interface element. In addition, the continuous scroll system 100 on the server(s) 804 can receive information relating to various interactions with content items and/or user interface elements based on the input received by the client device 808 (e.g., to generate an initial viewing pane to display content items and/or stacks of content items, to generate a set of label elements relating to stacks of content items displayed within the initial viewing pane, and to generate additional viewing panes to display a subset of a stack of content items and updated label elements based on the subset of the stack of content items).

As shown, the client device can include a client application 810. In particular, the client application 810 may be a web application, a native application installed on the client device 808 (e.g., a mobile application, a desktop application, etc.), or a cloud-based application where all or part of the functionality performed by the server(s) 804. Based on instructions from the client application 810, the client device 808 can present or display information, including a user interface for previewing and/or editing modified versions of content items.

As illustrated in FIG. 8, the example environment also includes the server(s) 804. The server(s) 804 may generate, track, store, process, receive, and transmit electronic data, such as digital content (e.g., content items), LLMs, position anchor elements, content items, metadata relating to content items, stacks of content items, label elements, or viewing panes within a single scrollable page of a scroll navigation interface, and/or interactions between user accounts or client devices. In addition, the server(s) 804 can transmit data to the client device 808 in the form of content items or notifications. Indeed, the server(s) 804 can communicate with the client device 808 to send and/or receive data via the network 812. In some implementations, the server(s) 804 include(s) a number of server devices distributed across the network 812 and located in different physical locations. The server(s) 804 can comprise one or more content servers, application servers, communication servers, web-hosting servers, machine learnings servers, and other types of servers.

As shown in FIG. 8, the server(s) 804 can also include the continuous scroll system 100 as part of the content management system 806. The content management system 806 can communicate with the client device 808 to perform various functions associated with the client application 810 such as managing user accounts, managing content collections (e.g., stacks of content items), managing content items, and facilitating user interaction with the content items and/or stacks of content items. Indeed, the content management system 806 can include a network-based smart cloud storage system to manage, store, and maintain content items, models, and related data across numerous user accounts, including user accounts in collaboration with one another.

Additionally, as shown in FIG. 8, the example environment includes third-party server(s) 816. The third-party server(s) 816 may generate, track, store, process, receive, and transmit electronic data, such as digital content (e.g., content items), stacks of content items, metadata relating to content items, stacks of content items, label elements, viewing panes within a single scrollable page of a scroll navigation interface interactions with interface elements, and/or interactions between user accounts or client devices. In addition, the third-party server(s) 816 can transmit data to the client device 808 in the form of content items, modified versions of content items, stacks of content items, metadata relating to content items, stacks of content items, label elements, viewing panes within a single scrollable page of a scroll navigation interface interactions with interface elements, and/or interactions between user accounts or client devices. Indeed, the third-party server(s) 816 can communicate with the client device 808 to send and/or receive data via the network 812. The third-party server(s) 816 can comprise one or more content servers, application servers, communication servers, web-hosting servers, machine learning servers, and other types of servers. In some embodiments, the continuous scroll system 100 can interface with the third-party servers 816 to access, store, modify, or otherwise interact with content items.

Although FIG. 8 depicts the continuous scroll system 100 located on the server(s) 804, in some implementations, the continuous scroll system 100 may be implemented by (e.g., located entirely on or in part on) one or more other components of the environment. For example, the continuous scroll system 100 may be implemented by the client device 808 and/or a third-party device. For example, the client device 808 can download all or part of the continuous scroll system 100 for implementation independent of, or together with, the server(s) 804 and/or third-party server(s) 816. Moreover, in some implementations, the continuous scroll system 100 may solely generate a single scrollable page within a scroll navigation interface.

In some implementations, though not illustrated in FIG. 8, the environment may have a different arrangement of components and/or may have a different number or set of components altogether. For example, the client device 808 may communicate directly with the continuous scroll system 100, bypassing the network 812. As another example, the environment can include a database located external to the server(s) 804 (e.g., in communication via the network 812) or located on the server(s), on a third-party system, and/or on the client device 808.

As mentioned above, the continuous scroll system 100 can generate a scroll navigation interface. The continuous scroll system can display content items and/or stacks of content items within viewing panes of a single scrollable page of the scroll navigation interface. Moreover, the continuous scroll system can return to an initial viewing pane of the single scrollable page responsive to receiving an indication of a vertical navigational input in the scroll navigation interface.

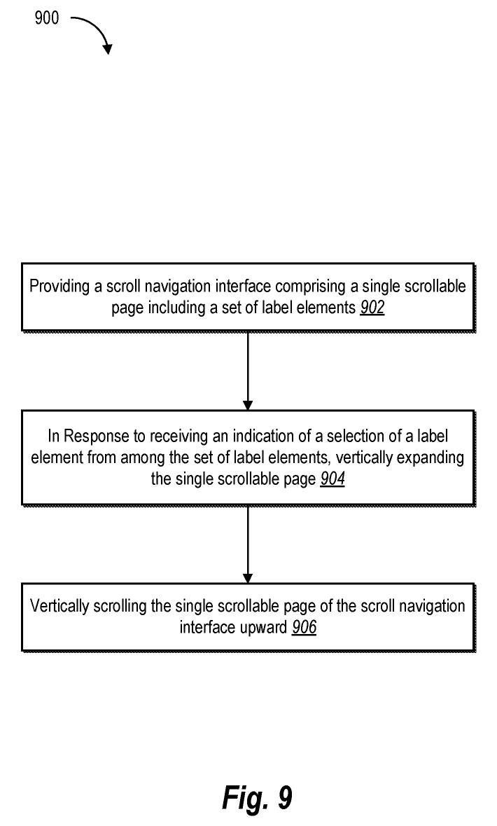

FIGS. 1-8, the corresponding text, and the examples provide a number of different systems and methods for generating a scroll navigation interface including a single scrollable page. In addition to the foregoing, implementations can also be described in terms of flowcharts comprising acts or steps in a method for accomplishing a particular result. For example, FIG. 9 illustrates an example series of acts for generating a single scrollable page within a scroll navigation interface to display varying amounts of stacks of content items within viewing panes of the single scrollable page.

While FIG. 9 illustrates acts according to certain implementations, alternative implementations may omit, add to, reorder and/or modify any of the acts shown in FIG. 9. The acts of FIG. 9 can be performed as part of a computer-implemented method. Alternatively, a non-transitory computer readable medium can comprise instructions, that when executed by one or more processors, cause a computing device to perform the acts of FIG. 9. In still further implementations, a system can perform the acts of FIG. 9.

As illustrated in FIG. 9, the series of acts 900 may include an act 902 of providing a scroll navigation interface comprising a single scrollable page including a set of label elements. Specifically the act 902 can include providing, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes for presenting content items corresponding to respective labels.

As shown, the series of acts 900 may include an act 904 of, in response to receiving an indication of a selection of a label element from among the set of label elements, vertically expanding the single scrollable page. Specifically, the act 904 can include, in response to receiving, from the client device, an indication of a selection of a label element from among the set of label elements, vertically expanding the single scrollable page by adding, below the initial viewing pane within the single scrollable page, a new viewing pane for viewing a subset of content items from the plurality of content items corresponding to the label element.

Moreover, as illustrated, the series of acts 900 may include an act 906 of vertically scrolling the single scrollable page of the scroll navigation interface upward. Specifically, the act 906 can include, in response to receiving an indication of an upward navigation input from the client device, vertically scrolling the single scrollable page of the scroll navigation interface upward from the new viewing pane back to the initial viewing pane.

Further, in some embodiments, the series of acts 900 can include generating, in response to the upward navigation input, a vertical scroll animation of the single scrollable page by providing visual indicia of vertically scrolling content reflecting a change from the new viewing pane to the initial viewing pane.

Additionally, in one or more embodiments, the series of acts 900 can include creating the set of label elements based on one or more of metadata associated with the plurality of content items or digital content within the plurality of content items.

Moreover, in some embodiments, the series of acts 900 can include providing, within the scroll navigation interface, a histogram comprising a plurality of viewing pane elements corresponding to respective viewing panes within the single scrollable page of the scroll navigation interface.

Indeed, in one or more embodiments, the series of acts 900 can include determining, responsive to detecting an indication of an interaction with a viewing pane element within the histogram, a viewing pane corresponding to the viewing pane element. Additionally, the series of acts 900 can include providing a preview of the viewing pane within a sub-window while maintaining display of the initial viewing pane within the single scrollable page.

Furthermore, in some embodiments, the series of acts 900 can include providing, within the scroll navigation interface, a search element including a search mode toggle selectable to alternate between a local search mode for searching content within a current viewing pane and a global search mode for searching content within the single scrollable page.

Additionally, in one or more embodiments, the series of acts 900 can include determining, based on a plurality of indications of navigational interactions, a viewing pane resulting from the navigational interactions. Further, the series of acts 900 can include based on navigating to the viewing pane resulting from the navigational interactions, providing, for display within the scroll navigation interface, a position anchor element selectable to store the plurality of indications of navigational interactions. Indeed, in some embodiments, the series of acts 900 can include, responsive to receiving an indication of an interaction with the position anchor element, returning to the viewing pane resulting from the navigational interactions by automatically applying the navigational interactions to the single scrollable page of the scroll navigation interface.

Moreover, in one or more embodiments, the series of acts 900 can include providing, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes for presenting content items corresponding to respective labels. Additionally, the series of acts 900 can include vertically expanding, in response to receiving, from the client device, an indication of a selection of a label element from among the set of label elements, the single scrollable page by adding, below the initial viewing pane within the single scrollable page, a new viewing pane for viewing a subset of content items from the plurality of content items corresponding to the label element. Further, the series of acts 900 can include providing, within the scroll navigation interface, a histogram comprising a plurality of viewing pane elements corresponding to respective viewing panes within the single scrollable page of the scroll navigation interface. Additionally, the series of acts 900 can include n response to receiving an indication of an upward navigation input from the client device, vertically scroll the single scrollable page of the scroll navigation interface upward from the new viewing pane back to the initial viewing pane.

Indeed, in some embodiments, the series of acts 900 can include generating a horizontal scroll viewing pane of the single scrollable page of the scroll navigation interface. Moreover, the series of acts 900 can include providing a second subset of content items for viewing within the horizontal scroll viewing pane.

Additionally, in one or more embodiments the series of acts 900 can include horizontally scrolling, in response to receiving an indication of a horizontal navigation input from the client device, the second subset of content items for viewing within the horizontal scroll viewing pane.

Moreover, in some embodiments, the series of acts 900 can include generating, in response to the upward navigation input, a vertical scroll animation of the single scrollable page by providing visual indicia of vertically scrolling content reflecting a change from the new viewing pane to the initial viewing pane.

Further, in one or more embodiments, the series of acts 900 can include receiving, via the scroll navigation interface, an indication of an interaction with a content item of the subset of content items. Additionally, the series of acts 900 can include providing the content item for display within an item viewing pane within the single scrollable page of the scroll navigation interface.

Indeed, in some embodiments, the series of acts 900 can include providing, within the scroll navigation interface, a search element including a search mode toggle selectable to alternate between a local search mode for searching content within a current viewing pane and a global search mode for searching content within the single scrollable page.

Moreover, in some embodiments, the series of acts 900 can include providing, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes within the single scrollable page of the scroll navigation interface for presenting content items corresponding to respective labels. Additionally, the series of acts 900 can include, in response to receiving, from the client device, an indication of a selection of a label element from among the set of label elements, vertically expanding the single scrollable page by adding, below the initial viewing pane within the single scrollable page, a new viewing pane for viewing a subset of content items from the plurality of content items corresponding to the label element. Indeed, the series of acts 900 can include in response to receiving an indication of an upward navigation input from the client device, vertically scrolling the single scrollable page of the scroll navigation interface upward from the new viewing pane back to the initial viewing pane. Furthermore, in one or more embodiments, the series of acts 900 can include horizontally scrolling, in response to receiving an indication of a horizontal navigation input from the client device, the subset of content items for viewing within the new viewing pane.

Additionally, in one or more embodiments, the series of acts 900 can include providing a visual indicial of vertically scrolling content within the single scrollable page of the scroll navigation interface.

Moreover, in some embodiments, the series of acts 900 can include providing, within the scroll navigation interface, a histogram comprising a plurality of viewing pane elements corresponding to respective viewing panes within the single scrollable page of the scroll navigation interface, wherein each of the plurality of viewing pane elements corresponds to a viewing pane layer of a plurality of viewing pane layers.

Indeed, in one or more embodiments, the series of acts 900 can include determining, responsive to detecting an indication of an interaction with a viewing pane element within the histogram, an additional viewing pane corresponding to the viewing pane element. Additionally, the series of acts 900 can include providing a preview of the additional viewing pane within a sub-window of the initial viewing pane while maintaining display of the initial viewing pane within the single scrollable page.

Further, in some embodiments, the series of acts 900 can include determining, based on a plurality of indications of navigational interactions within the single scrollable page of the scroll navigation interface, an additional viewing pane resulting from the navigational interactions. Additionally, the series of acts 900 can include, based on navigating to the additional viewing pane, providing, for display within the single scrollable page of the scroll navigation interface, a position anchor element selectable to store the plurality of indications of navigational interactions.

The components of the continuous scroll system 100 can include software, hardware, or both. For example, the components of the continuous scroll system 100 can include one or more instructions stored on a computer-readable storage medium executable by processors of one or more computing devices. When executed by one or more processors, the computer-executable instructions of the continuous scroll system 100 can cause a computing device to perform the methods described herein. Alternatively, the components of the continuous scroll system 100 can comprise hardware, such as a special processing device to perform a certain function or group of functions. Additionally or alternatively, the components of the continuous scroll system 100 can include a combination of computer-executable instructions and hardware.

Furthermore, the components of the continuous scroll system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the continuous scroll system 100 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server(s) 804 and/or the client device 808) that may be configured to perform one or more of the processes described above. One will appreciate that server(s) 804 and/or the client device 808 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

FIG. 11 is a schematic diagram illustrating environment 1100 within which one or more implementations of the continuous scroll system 100 can be implemented. For example, the continuous scroll system 100 may be part of a content management system 1102 (e.g., the content management system 1102). Content management system 1102 may generate, store, manage, receive, and send digital content (such as digital content items). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1106. The content management system 1102 can cause client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from content management system 1102. In particular, upon a user selecting a reduced-sized version of digital content, client device 1106 sends a request to content management system 1102 requesting the digital content associated with the reduced-sized version of the digital content. Content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes for presenting content items corresponding to respective labels;
in response to receiving, from the client device, an indication of a selection of a label element from among the set of label elements, vertically expanding the single scrollable page by adding, below the initial viewing pane within the single scrollable page, a new viewing pane for viewing a subset of content items from the plurality of content items corresponding to the label element; and
in response to receiving an indication of an upward navigation input from the client device, vertically scrolling the single scrollable page of the scroll navigation interface upward from the new viewing pane back to the initial viewing pane.

2. The computer-implemented method of claim 1, further comprising generating, in response to the upward navigation input, a vertical scroll animation of the single scrollable page by providing visual indicia of vertically scrolling content reflecting a change from the new viewing pane to the initial viewing pane.

3. The computer-implemented method of claim 1, further comprising:
creating the set of label elements based on one or more of metadata associated with the plurality of content items or digital content within the plurality of content items.

4. The computer-implemented method of claim 1, further comprising:
providing, within the scroll navigation interface, a histogram comprising a plurality of viewing pane elements corresponding to respective viewing panes within the single scrollable page of the scroll navigation interface.

5. The computer-implemented method of claim 4, further comprising:
determining, responsive to detecting an indication of an interaction with a viewing pane element within the histogram, a viewing pane corresponding to the viewing pane element; and
providing a preview of the viewing pane within a sub-window while maintaining display of the initial viewing pane within the single scrollable page.

6. The computer-implemented method of claim 1, further comprising providing, within the scroll navigation interface, a search element including a search mode toggle selectable to alternate between a local search mode for searching content within a current viewing pane and a global search mode for searching content within the single scrollable page.

7. The computer-implemented method of claim 1, further comprising:
determining, based on a plurality of indications of navigational interactions, a viewing pane resulting from the navigational interactions; and
based on navigating to the viewing pane resulting from the navigational interactions, providing, for display within the scroll navigation interface, a position anchor element selectable to store the plurality of indications of navigational interactions.

8. The computer-implemented method of claim 7, further comprising:
responsive to receiving an indication of an interaction with the position anchor element, returning to the viewing pane resulting from the navigational interactions by automatically applying the navigational interactions to the single scrollable page of the scroll navigation interface.

9. A system comprising:
at least one processor; and
at least one non-transitory computer readable storage medium storing instructions that, when executed by the at least one processor, cause the system to:
provide, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes for presenting content items corresponding to respective labels;
vertically expand, in response to receiving, from the client device, an indication of a selection of a label element from among the set of label elements, the single scrollable page by adding, below the initial viewing pane within the single scrollable page, a new viewing pane for viewing a subset of content items from the plurality of content items corresponding to the label element;
provide, within the scroll navigation interface, a histogram comprising a plurality of viewing pane elements corresponding to respective viewing panes within the single scrollable page of the scroll navigation interface; and
in response to receiving an indication of an upward navigation input from the client device, vertically scroll the single scrollable page of the scroll navigation interface upward from the new viewing pane back to the initial viewing pane.

10. The system of claim 9, further comprising instructions that, when executed by the at least one processor, cause the system to:
generate a horizontal scroll viewing pane of the single scrollable page of the scroll navigation interface; and
provide a second subset of content items for viewing within the horizontal scroll viewing pane.

11. The system of claim 10, further comprising instructions that, when executed by the at least one processor, cause the system to horizontally scroll, in response to receiving an indication of a horizontal navigation input from the client device, the second subset of content items for viewing within the horizontal scroll viewing pane.

12. The system of claim 9, further comprising instructions that, when executed by the at least one processor, cause the system to generate, in response to the upward navigation input, a vertical scroll animation of the single scrollable page by providing visual indicia of vertically scrolling content reflecting a change from the new viewing pane to the initial viewing pane.

13. The system of claim 9, further comprising instructions that, when executed by the at least one processor, cause the system to:
receive, via the scroll navigation interface, an indication of an interaction with a content item of the subset of content items; and
provide the content item for display within an item viewing pane within the single scrollable page of the scroll navigation interface.

14. The system of claim 9, further comprising instructions that, when executed by the at least one processor, cause the system to provide, within the scroll navigation interface, a search element including a search mode toggle selectable to alternate between a local search mode for searching content within a current viewing pane and a global search mode for searching content within the single scrollable page.

15. A non-transitory computer-readable medium storing instructions thereon that, when executed by at least one processor, cause a computing device to:
provide, for display on a client device, a scroll navigation interface comprising a single scrollable page that facilitates vertical scrolling navigation through a plurality of content items by providing label-specific viewing panes within the single scrollable page, wherein the scroll navigation interface includes an initial viewing pane for viewing the plurality of content items and also includes a set of label elements selectable to create respective viewing panes within the single scrollable page of the scroll navigation interface for presenting content items corresponding to respective labels;
in response to receiving, from the client device, an indication of a selection of a label element from among the set of label elements, vertically expand the single scrollable page by adding, below the initial viewing pane within the single scrollable page, a new viewing pane for viewing a subset of content items from the plurality of content items corresponding to the label element; and
in response to receiving an indication of an upward navigation input from the client device, vertically scroll the single scrollable page of the scroll navigation interface upward from the new viewing pane back to the initial viewing pane.

16. The non-transitory computer-readable medium of claim 15, further comprising instructions that, when executed by the at least one processor, cause the computing device to horizontally scroll, in response to receiving an indication of a horizontal navigation input from the client device, the subset of content items for viewing within the new viewing pane.

17. The non-transitory computer-readable medium of claim 15, further comprising instructions that, when executed by the at least one processor, cause the computing device to provide a visual indicial of vertically scrolling content within the single scrollable page of the scroll navigation interface.

18. The non-transitory computer-readable medium of claim 15, further comprising instructions that, when executed by the at least one processor, cause the computing device to provide, within the scroll navigation interface, a histogram comprising a plurality of viewing pane elements corresponding to respective viewing panes within the single scrollable page of the scroll navigation interface, wherein each of the plurality of viewing pane elements corresponds to a viewing pane layer of a plurality of viewing pane layers.

19. The non-transitory computer-readable medium of claim 18, further comprising instructions that, when executed by the at least one processor, cause the computing device to:
determine, responsive to detecting an indication of an interaction with a viewing pane element within the histogram, an additional viewing pane corresponding to the viewing pane element; and
provide a preview of the additional viewing pane within a sub-window of the initial viewing pane while maintaining display of the initial viewing pane within the single scrollable page.

20. The non-transitory computer-readable medium of claim 15, further comprising instructions that, when executed by the at least one processor, cause the computing device to:
determine, based on a plurality of indications of navigational interactions within the single scrollable page of the scroll navigation interface, an additional viewing pane resulting from the navigational interactions; and
based on navigating to the additional viewing pane, providing, for display within the single scrollable page of the scroll navigation interface, a position anchor element selectable to store the plurality of indications of navigational interactions.
